(19) United States
(12) Patent Application Publication
(10) Pub. No.: US 2026/0244076 A1
(43) Pub. Date: Aug. 20, 2026

(54) UNIT WITH SHAKE CORRECTION FUNCTION

(71) Applicant: NIDEC INSTRUMENTS CORPORATION, Nagano (JP)

(72) Inventor: Shogo KASAHARA, Nagano (JP)

(21) Appl. No.: 19/538,985

(22) Filed: Feb. 13, 2026

(30) Foreign Application Priority Data
Feb. 14, 2025 (JP) 2025-022183

(51) Int. Cl. G03B 5/00; H04N 23/54; H04N 23/57; H04N 23/68

(52) U.S. Cl. CPC G03B 5/00; H04N 23/54; H04N 23/57; H04N 23/6812; H04N 23/687; G03B 2205/0069

(57) ABSTRACT

A unit with a shake correction function includes a gimbal mechanism swingably supporting a movable body by a support body. The gimbal mechanism includes a gimbal frame, a pair of first swing support parts and a pair of second swing support parts point contacting with the gimbal frame. The movable body includes a pair of first support parts supporting the first swing support parts, and the support body includes a pair of second support parts supporting the second swing support parts. The unit further includes at least one of a pair of first stopper parts facing the first support parts and a pair of second stopper parts facing the second support parts. The first swing support part is held between the first stopper part and the first support part, and the second swing support part is held between the second stopper part and the second support part.

### CROSS REFERENCE TO RELATED APPLICATION

The present invention claims priority under 35 U.S.C. § 119 to Japanese Application No. 2025-022183 filed Feb. 14, 2025, the entire content of which is incorporated herein by reference.

### FIELD OF THE INVENTION

At least an embodiment of the present invention may relate to a unit with a shake correction function.

### BACKGROUND

Japanese Patent Laid-Open No. 2017-146571 (Patent Literature 1) discloses an optical unit with a shake correction function which is structured to swing a movable body carrying an optical module for photographing around a first axis intersecting an optical axis of the optical module and around a second axis intersecting the optical axis and the first axis. The optical unit with a shake correction function described in Patent Literature 1 swingably supports the movable body using a gimbal mechanism.

The gimbal mechanism described in Patent Literature 1 includes a movable frame (gimbal frame) in a rectangular frame shape, a pair of plate springs disposed at diagonal positions in the first axis direction of the movable body, and a pair of plate springs disposed at diagonal positions in the second axis direction of a fixed body. Metal spheres are respectively fixed at diagonal positions in the first axis direction of the movable frame and at diagonal positions in its second axis direction by welding. The plate springs at four positions are respectively provided with a hemispheric recessed part. The recessed part is brought into point contact with the sphere which is welded to the movable frame by an elastic force of the plate spring. As a result, the movable body is supported by the fixed body in a swingable state around the first axis and around the second axis.

In the structure that a movable body and a support body are connected with each other by a gimbal mechanism, when a strong impact is applied by falling and the like, a component structuring the gimbal mechanism may be largely deformed to cause the movable body to fall off from the gimbal mechanism. Alternatively, a component structuring the gimbal mechanism falls off from between the movable body and the support body and, as a result, the movable body may fall off from the gimbal mechanism.

### SUMMARY

In view of the problem described above, at least an embodiment of the present invention may advantageously provide a unit with a shake correction function in which a movable body having a swung object such as an optical module is swingably supported by a gimbal mechanism and a risk that the movable body falls off is reduced even when a strong impact is applied.

According to at least an embodiment of the present invention, there may be provided a unit with a shake correction function including a movable body and a support body, and a gimbal mechanism which connects the movable body with the support body and swingably supports the movable body with respect to the support body. In a case that an axis intersecting a center axis line passing a swing center of the movable body at the swing center is defined as a first axis, and an axis intersecting the center axis line and the first axis at the swing center is defined as a second axis, the gimbal mechanism includes a gimbal frame, a pair of first swing support parts which are brought into point contact with the gimbal frame on the first axis, and a pair of second swing support parts which are brought into point contact with the gimbal frame on the second axis, the movable body includes a pair of first support parts which support the pair of the first swing support parts, and the support body includes a pair of second support parts which support the pair of the second swing support parts. The unit further includes at least one of a pair of first stopper parts which face the pair of the first support parts in an axial line direction along the center axis line and a pair of second stopper parts facing the pair of the second support parts in the axial line direction, the first swing support part is held between the first stopper part and the first support part, and the second swing support part is held between the second stopper part and the second support part.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outside perspective view showing a unit with a shake correction function.

FIG. 2 is an outside perspective view showing a unit with a shake correction function from which a cover is detached.

FIG. 3 is an exploded perspective view showing a unit with a shake correction function.

FIG. 4 is an exploded perspective view showing a first stopper member, a gimbal mechanism and a holder.

FIG. 5 is a cross-sectional view showing a unit with a shake correction function which is cut by a plane including a first axis and a second axis.

FIG. 6 is a cross-sectional view showing a unit with a shake correction function which is cut by a plane including a first axis and a center axis line and is a partially enlarged view showing a first swing support part.

FIG. 7 is a cross-sectional view showing a unit with a shake correction function which is cut by a plane including a second axis and a center axis line and is a partially enlarged view of a second swing support part.

FIG. 8 is a perspective view showing a state that first magnets and second magnets are positioned by a second stopper member and fixed to a cover.

FIG. 9 is an exploded perspective view showing a contact member and a spring member.

FIG. 10 is an exploded perspective view showing a state that angular positions of cut-out parts of a first stopper member and projections provided on a tube part of a holder are aligned with each other.

FIG. 11 is a perspective view showing a state that a first stopper member is fitted to a holder and before a first stopper member is locked by projections.

FIG. 12 is a perspective view showing a state that a first stopper member has been locked by projections.

### DETAILED DESCRIPTION

An embodiment of a unit with a shake correction function to which the present invention is applied will be described below with reference to the accompanying drawings.

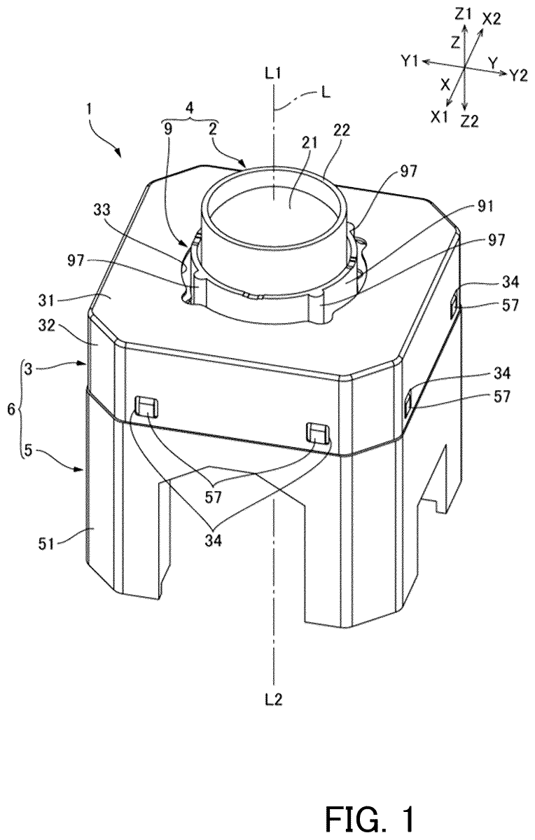

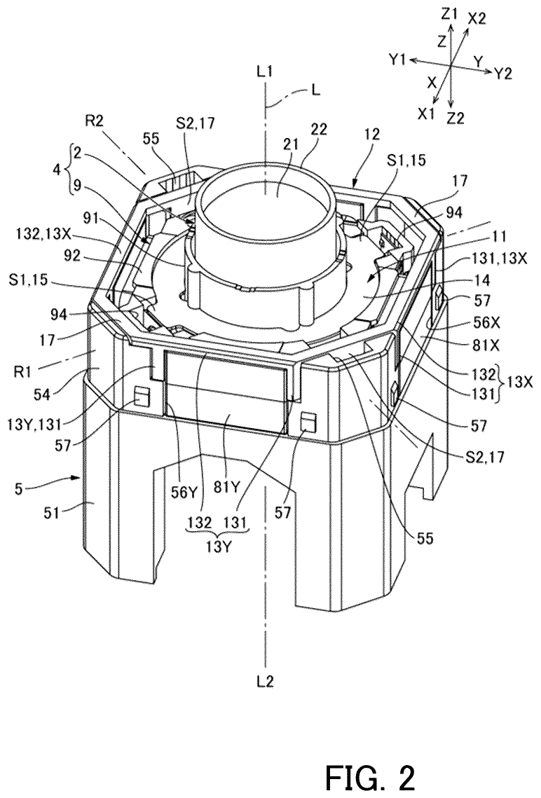

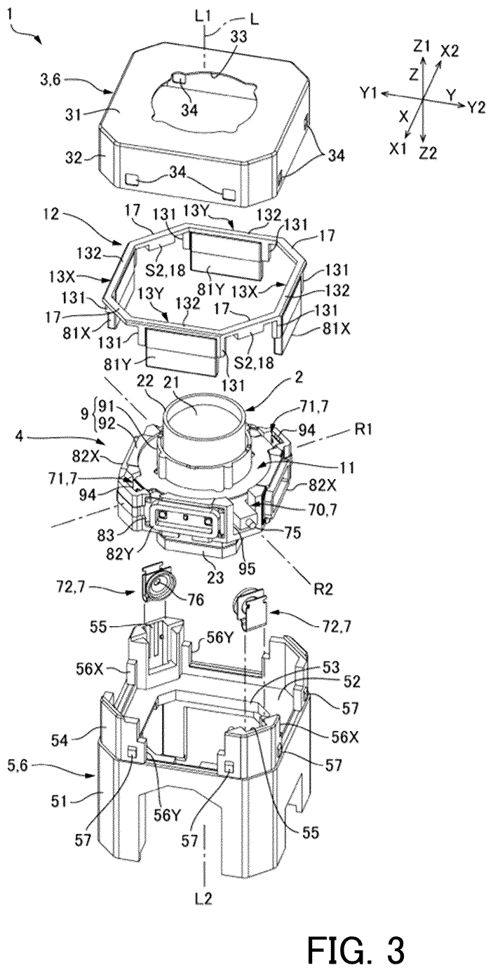

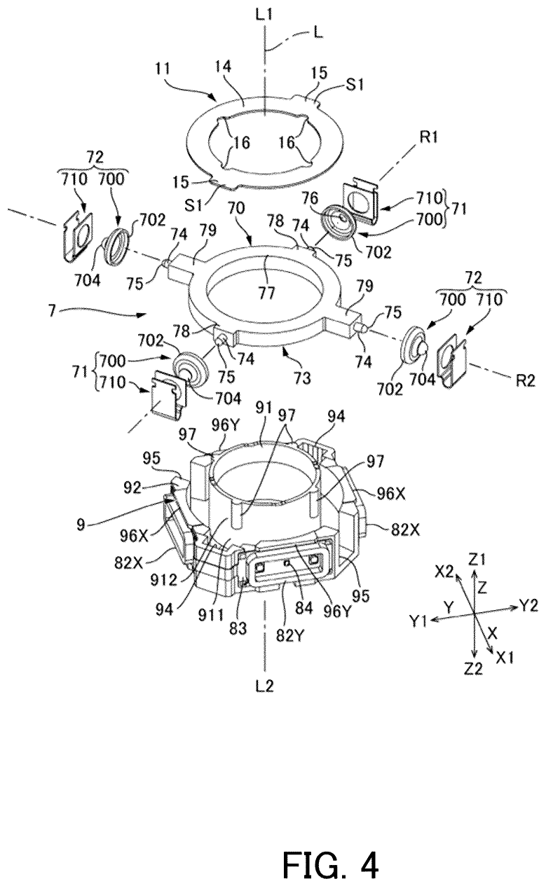

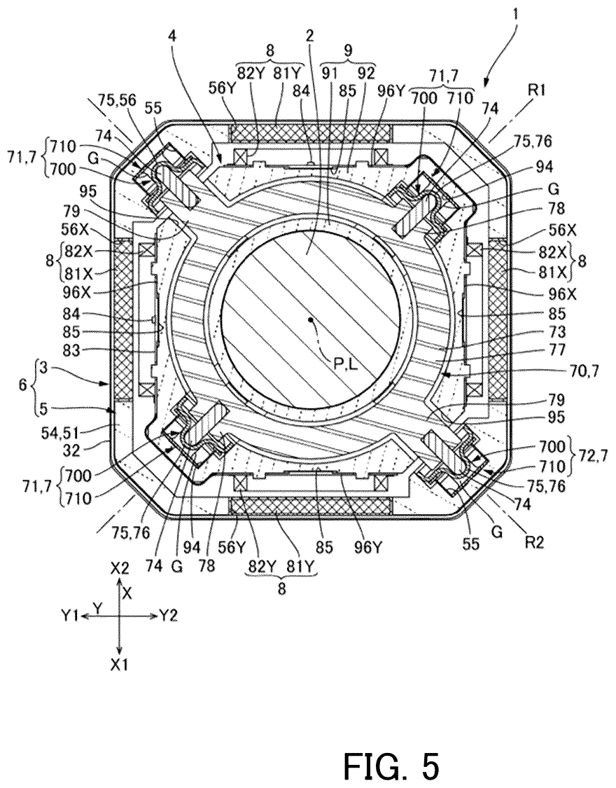

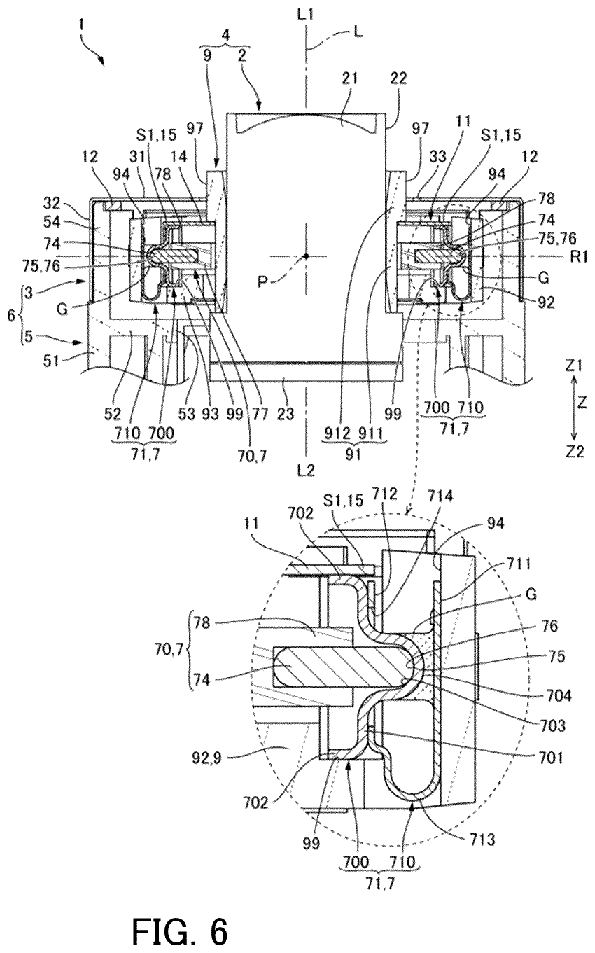

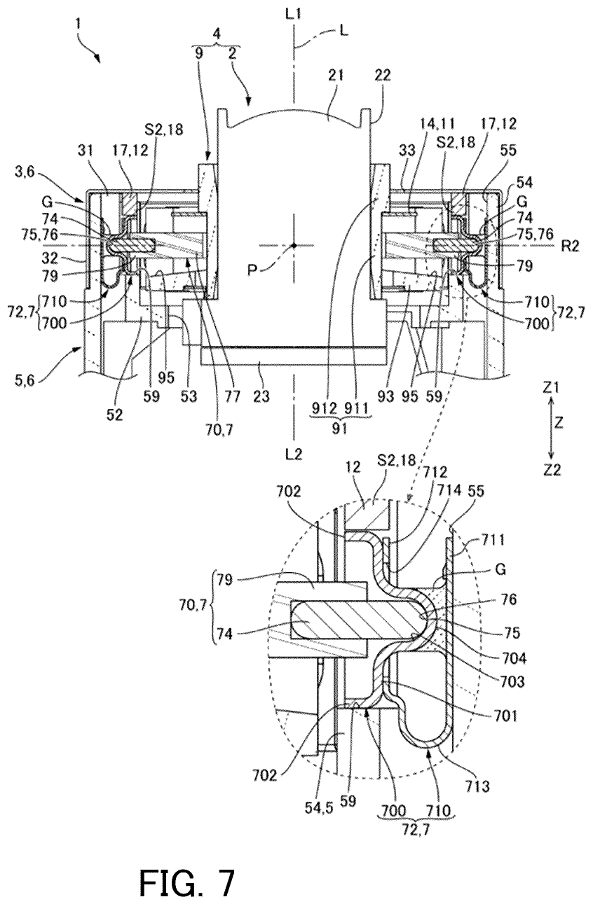

FIG. 1 is an outside perspective view showing a unit 1 with a shake correction function. FIG. 2 is an outside perspective view showing the unit 1 with a shake correction function from which a cover 3 is detached. FIG. 3 is an exploded perspective view showing the unit 1 with a shake correction function. FIG. 4 is an exploded perspective view showing a first stopper member 11, a gimbal mechanism 7 and a holder 9. FIG. 5 is a cross-sectional view showing the unit 1 with a shake correction function which is cut by a plane including a first axis R1 and a second axis R2. FIG. 6 is a cross-sectional view showing the unit 1 with a shake correction function which is cut by a plane including the first axis R1 and a center axis line L and is a partially enlarged view showing a first swing support part 71. FIG. 7 is a cross-sectional view showing the unit 1 with a shake correction function which is cut by a plane including the second axis R2 and the center axis line L and is a partially enlarged view of a second swing support part 72.

A unit 1 with a shake correction function performs a tilt operation which swings a movable body 4 on which a swung object is disposed. The swung object is not especially limited but, for example, may include an optical module having optical members such as a lens and a prism, a reflection member such as a mirror, an antenna, a light emitting element such as a laser diode, and the like. The unit 1 with a shake correction function, for example, swings the movable body 4 based on a control signal from a host apparatus. In this embodiment, the movable body 4 may include no swung object and may be provided with a member for holding a swung object.

Next, an embodiment of the unit 1 with a shake correction function will be described below when a swung object is a camera module 2. The unit 1 with a shake correction function is assumed to be incorporated into an action camera which is mounted and used in various equipment. For example, the unit 1 with a shake correction function can be mounted and used in a bow gun for hunting, a shotgun and the like.

### Entire Structure

As shown in FIGS. 1 through 7, the unit 1 with a shake correction function includes a movable body 4 having a camera module 2, a support body 6 having a case 5 surrounding an outer periphery of the movable body 4 and a cover 3 fixed to the case 5, a gimbal mechanism 7 connecting the movable body 4 with the support body 6, and a swing magnetic drive mechanism 8 which generates a magnetic drive force for swinging the movable body 4. As shown in FIGS. 3, 6 and 7, the camera module 2 includes a lens 21 which structures an imaging optical system, a lens barrel 22 which holds the lens 21, and a board 23 on which an imaging element is mounted.

As shown in FIGS. 5, 6 and 7, a swing center P of the movable body 4 is located on a center axis line L of the camera module 2. The center axis line L is coincided with an optical axis of the camera module 2. In the following descriptions, a direction along the center axis line L is defined as an axial line direction, one side in the axial line direction is referred to as L1, and the other side in the axial line direction is referred to as L2. The one side L1 in the axial line direction is an object side with respect to the camera module 2, and the other side L2 in the axial line direction is an image side with respect to the camera module 2.

In the following descriptions, three axes perpendicular to each other are defined as an X-axis, a Y-axis and a Z-axis, a direction along the X-axis is referred to as an X-axis direction, a direction along the Y-axis is referred to as a Y-axis direction, and a direction along the Z-axis is referred to as a Z-axis direction. Further, one side in the X-axis direction is referred to as an X1-direction, the other side in the X-axis direction is referred to as an X2-direction, one side in the Y-axis direction is a Y1-direction, the other side in the Y-axis direction is a Y2-direction, one side in the Z-axis direction is a Z1-direction, and the other side in the Z-axis direction is a Z2-direction. The Z-axis is coincided with the center axis line L when the camera module 2 which is a swung object is located at an origin position. The Z1-direction is coincided with one side L1 in the axial line direction, and the Z2-direction is coincided with the other side L2 in the axial line direction.

The gimbal mechanism 7 swingably supports the movable body 4 with a first axis R1 as a center and swingably supports the movable body 4 with a second axis R2 as a center. The first axis R1 and the second axis R2 intersect each other and intersect the center axis line L at the swing center P of the movable body 4. The first axis R1 and the second axis R2 are inclined with respect to the X-axis and the Y-axis around the Z-axis. In this embodiment, the first axis R1 and the second axis R2 are inclined with respect to the X-axis and the Y-axis by 45 degrees around the Z-axis. In the following descriptions, a direction along the first axis R1 is referred to as a first axis direction, and a direction along the second axis R2 is referred to as a second axis direction.

The unit 1 with a shake correction function performs a combined operation in which an operation for swinging the movable body 4 around the first axis with the first axis R1 as a center and an operation for swinging the movable body 4 around the second axis with the second axis R2 as a center are combined with each other. As a result, an angular position around the X-axis of a swung object disposed on the movable body 4 and an angular position around the Y-axis of the swung object are adjusted.

The unit 1 with a shake correction function includes a first stopper member 11 disposed on the movable body 4 and a second stopper member 12 disposed on the support body 6. The first stopper member 11 prevents a component structuring the gimbal mechanism 7 from deforming or falling off from the movable body 4. The second stopper member 12 prevents a component structuring the gimbal mechanism 7 from deforming or falling off from the support body 6.

### Holder

As shown in FIGS. 3 through 7, the movable body 4 includes the camera module 2 and the holder 9 which holds the camera module 2. The holder 9 is provided with a cylindrical part 91 extending in the axial line direction, a wall part 92 surrounding an outer periphery of the cylindrical part 91, and a connection part 93 connecting the wall part 92 with the cylindrical part 91. As shown in FIG. 6, the connection part 93 connects end parts on the other side L2 in the axial line direction of the cylindrical part 91 and the wall part 92 with each other. The cylindrical part 91 is formed in a cylindrical shape. An inner peripheral face of the wall part 92 is a cylindrical face surrounding an outer periphery of the cylindrical part 91. A ring-shaped recessed part which accommodates components of the gimbal mechanism 7 is formed between an inner peripheral face of the wall part 92 and an outer peripheral face of the cylindrical part 91.

As shown in FIGS. 3, 6 and 7, the lens barrel 22 of the camera module 2 is held on an inner side of the cylindrical part 91. A tip end of the lens barrel 22 is protruded from the cylindrical part 91 to one side L1 in the axial line direction. The board 23 on which an imaging element is mounted is disposed at an end part of the lens barrel 22 which is protruded from the cylindrical part 91 to the other side L2 in the axial line direction.

As shown in FIGS. 4 and 5, an outer peripheral face of the wall part 92 is formed in a rectangular shape whose four corners in diagonal directions are cut out when viewed in the axial line direction. The diagonal directions of the wall part 92 are coincided with the first axis direction and the second axis direction. The wall part 92 is provided with a pair of first recessed parts 94 which are recessed from its inner peripheral face to an outer peripheral side at diagonal positions in the first axis direction. The wall part 92 is provided with groove parts 95 penetrating through the wall part 92 in the second axis direction at diagonal positions in the second axis direction.

As shown in FIG. 5, the outer peripheral face of the wall part 92 is provided with a pair of first coil arrangement parts 96X which are located on both sides in the Y-axis direction with respect to the cylindrical part 91, and a pair of second coil arrangement parts 96Y which are located on both sides in the X-axis direction with respect to the cylindrical part 91. The first coil arrangement part 96X is disposed with a first coil 82X of the swing magnetic drive mechanism 8 for swinging. The second coil arrangement part 96Y is disposed with a second coil 82Y of the swing magnetic drive mechanism 8.

The cylindrical part 91 is protruded from an inner side of the wall part 92 to one side L1 in the axial line direction. As shown in FIG. 4, the cylindrical part 91 is provided with a base part 911 disposed on an inner side with respect to the wall part 92 and a tip end part 912 which is protruded to one side L1 in the axial line direction with respect to the wall part 92. An outer peripheral face of the tip end part 912 is formed with projections 97 which are extended in the axial line direction. The projection 97 is disposed at a plurality of positions in a circumferential direction so as to be separated from each other. In this embodiment, the projection 97 is disposed at four positions at an equal angle interval. A cross-sectional shape of the projection 97 is semi-circular.

### Case

As shown in FIG. 3, the case 5 is provided with a body part 51 which surrounds an outer periphery of the movable body 4 and a bottom plate part 52 which extends from an intermediate position in the axial line direction of the body 51 to an inner peripheral side. As shown in FIGS. 6 and 7, the holder 9 is disposed on one side L1 in the axial line direction with respect to the bottom plate part 52. The other side L2 in the axial line direction with respect to the bottom plate part 52 is disposed with an end part of the lens barrel 22 of the camera module 2, which is protruded from an opening part 53 provided at a center of the bottom plate part 52 to the other side L2 in the axial line direction, the board 23, and a flexible printed board (not shown) which is extended from the board 23.

An outward shape of the body part 51 when viewed in the axial line direction is formed in a rectangular shape whose four corners in the diagonal directions are cut out. The diagonal directions of the body part 51 are coincided with the first axis direction and the second axis direction. The body part 51 is provided with a body tip end part 54 extending from the bottom plate part 52 to one side L1 in the axial line direction, and the holder 9 is disposed on an inner side with respect to the body tip end part 54. As shown in FIGS. 3 and 5, a pair of second recessed parts 55 which are recessed from an inner peripheral face of the body tip end part 54 to an outer peripheral side is provided at diagonal positions in the second axis direction of the body tip end part 54.

The body tip end part 54 is provided with a pair of first magnet arrangement parts 56X which are located on both sides in the Y-axis direction with respect to the holder 9, and a pair of second magnet arrangement parts 56Y which are located on both sides in the X-axis direction with respect to the holder 9. The first magnet arrangement part 56X and the second magnet arrangement part 56Y are cut-out parts which are respectively formed by cutting out from an end part on one side L1 in the axial line direction of the body tip end part 54 to the other side L2 in the axial line direction. As shown in FIGS. 2 and 5, a first magnet 81X of the swing magnetic drive mechanism 8 is disposed in the first magnet arrangement part 56X. A second magnet 81Y of the swing magnetic drive mechanism 8 is disposed in the second magnet arrangement part 56Y.

### Cover

As shown in FIGS. 1, 2, 6 and 7, the cover 3 is provided with an end plate part 31 contacting with the case 5 from one side L1 in the axial line direction, and a side plate part 32 which is extended from an outer circumferential edge of the end plate part 31 to the other side L2 in the axial line direction and surrounds an outer periphery of the body tip end part 54. When the cover 3 is attached to the case 5, the cylindrical part 91 of the holder 9 is protruded from an opening part 33 provided at a center of the end plate part 31 to one side L1 in the axial line direction. The cover 3 is fixed to the case 5 by engaging locking holes 34 provided in the side plate part 32 with hooks 57 projecting from an outer peripheral face of the body tip end part 54.

### Swing Magnetic Drive Mechanism for Swinging

As shown in FIG. 5, the swing magnetic drive mechanism 8 includes the first magnet 81X and the second magnet 81Y which are disposed on the support body 6, and the first coil 82X and the second coil 82Y which are fixed to the movable body 4. In this case, it may be structured that the first coil 82X and the second coil 82Y are disposed on the support body 6, and the first magnet 81X and the second magnet 81Y are disposed on the movable body 4.

The first magnet 81X and the second magnet 81Y are fixed to an inner peripheral face of the side plate part 32 of the cover 3. As described above, the body tip end part 54 of the case 5 is provided with a pair of the first magnet arrangement parts 56X and a pair of the second magnet arrangement parts 56Y which are opened to one side L1 in the axial line direction. Therefore, when the cover 3 which is fixed with the first magnets 81X and the second magnets 81Y is attached to the case 5 from one side L1 in the axial line direction, the first magnets 81X are respectively disposed in a pair of the first magnet arrangement parts 56X, and the second magnets 81Y are respectively disposed in a pair of the second magnet arrangement parts 56Y. The cover 3 is made of magnetic metal. Therefore, the side plate part 32 of the cover 3 functions as a yoke.

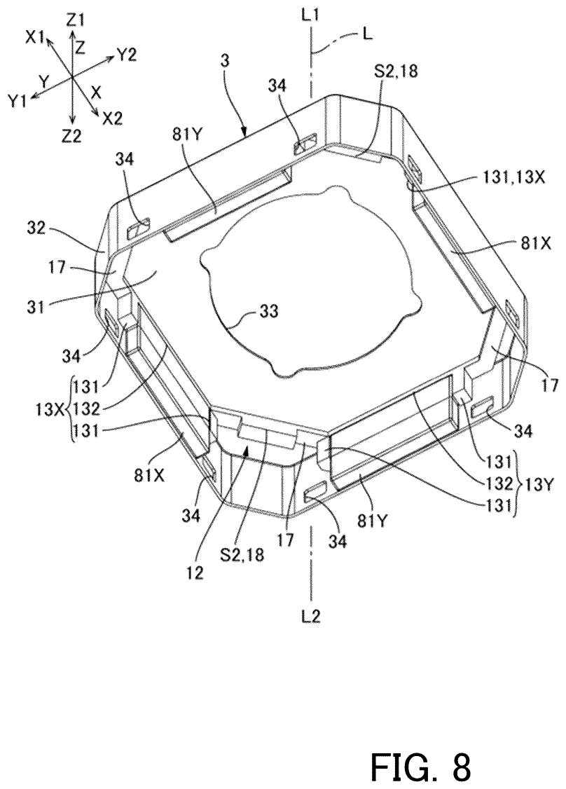

FIG. 8 is a perspective view showing a state that the first magnets 81X and the second magnets 81Y are positioned by the second stopper member 12 and fixed to the cover 3. In this embodiment, the second stopper member 12 is fixed to an inner side of the cover 3. As a result, when the first magnets 81X and the second magnets 81Y are to be fixed to the cover 3, the first magnets 81X and the second magnets 81Y are positioned by the second stopper member 12. As shown in FIGS. 3 and 8, the second stopper member 12 is provided with two magnet positioning parts 13X for holding the first magnets 81X and two magnet positioning parts 13Y for holding the second magnets 81Y.

As shown in FIG. 8, when the second stopper member 12 is fitted to an inner side of the cover 3, the magnet positioning part 13X is disposed on inner faces in the Y1-direction and the Y2-direction of the side plate part 32, and the magnet positioning part 13Y is disposed on inner faces in the X1-direction and the X2-direction of the side plate part 32. The magnet positioning parts 13X and 13Y are respectively provided with a pair of side frame parts 131, which are extended in the axial line direction along edges on both sides in a width direction of each of the magnets, and an upper frame part 132 which connects end parts on one side L1 in the axial line direction of a pair of the side frame parts 131 with each other. The first magnet 81X and the second magnet 81Y are respectively fitted to recessed parts structured by a pair of the side frame parts 131 and the upper frame part 132.

As shown in FIGS. 2 and 3, the first magnet arrangement part 56X and the second magnet arrangement part 56Y of the case 5 are respectively formed with recessed parts in a shape to which the side frame parts 131 are fitted on inner faces in the width direction. Therefore, the first magnet 81X is fitted to the first magnet arrangement part 56X together with the side frame part 131, and the second magnet 81Y is fitted to the second magnet arrangement part 56Y together with the side frame part 131.

The first coil 82X and the second coil 82Y are fixed to an outer peripheral face of the wall part 92 of the holder 9. As described above, the wall part 92 is provided with a pair of the first coil arrangement parts 96X and a pair of the second coil arrangement parts 96Y. As shown in FIGS. 3 and 5, a flexible printed board 83 is provided on an outer peripheral face of the wall part 92. The first coil 82X is fixed to the first coil arrangement part 96X through the flexible printed board 83. The second coil 82Y is fixed to the second coil arrangement part 96Y through the flexible printed board 83. The first coil 82X and the second coil 82Y are electrically connected with the flexible printed board 83 and are supplied with power through the flexible printed board 83.

As shown in FIG. 5, the swing magnetic drive mechanism 8 includes two pairs of the first magnet 81X and the first coil 82X which face each other in the Y-axis direction, and two pairs of the second magnet 81Y and the second coil 82Y which face each other in the X-axis direction. The pair of the first magnet 81X and the first coil 82X generates a magnetic drive force which swings the movable body 4 around the X-axis. The pair of the second magnet 81Y and the second coil 82Y generates a magnetic drive force which swings the movable body 4 around the Y-axis.

As shown in FIG. 4, the flexible printed board 83 is connected with a magnetic sensor 84 which is disposed on an inner side with respect to the first coil 82X and the second coil 82Y. Further, a magnetic member 85 for origin return is fixed to the flexible printed board 83. The swing magnetic drive mechanism 8 detects an angular position of the movable body 4 based on outputs of the magnetic sensors 84. When power supply to the first coil 82X and the second coil 82Y is stopped, the movable body 4 is returned to an origin position by magnetic attraction forces of the first magnet 81X and the second magnet 81Y which attract the magnetic members 85.

### Gimbal Mechanism

As shown in FIGS. 4 and 5, the gimbal mechanism 7 includes a gimbal frame 70, a pair of first swing support parts 71 which are brought into point contact with the gimbal frame 70 on the first axis R1, and a pair of second swing support parts 72 which are brought into point contact with the gimbal frame 70 on the second axis R2. As shown in FIGS. 3 and 5, a pair of the first swing support parts 71 is disposed on the movable body 4. In this embodiment, a pair of the first swing support parts 71 is disposed on first recessed parts 94 of the holder 9. A pair of the second swing support parts 72 is disposed on the support body 6. In this embodiment, a pair of the second swing support parts 72 is disposed on the second recessed parts 55 of the case 5.

As shown in FIG. 4, the gimbal frame 70 is provided with a gimbal frame main body 73 made of rigid body, and four shafts 74 which are protruded from both ends in the first axis direction of gimbal frame main body 73 and protruded from both ends in the second axis direction of the gimbal frame main body 73. A tip end of each of the four shafts 74 is provided with a projecting curved face 75 in a hemispheric shape. A pair of the first swing support parts 71 and a pair of the second swing support parts 72 are respectively provided with a concave curved face 76 which is recessed toward an outer peripheral side. The concave curved face 76 is brought into point contact with the projecting curved face 75 of the gimbal frame 70.

The gimbal frame main body 73 is provided with a ring-shaped frame part 77, a pair of first arm parts 78 protruding from the frame part 77 to both sides in the first axis direction, and a pair of second arm parts 79 protruding from the frame part 77 to both sides in the second axis direction. The shafts 74 are fixed to mounting holes which are opened at tip end faces of the first arm parts 78 and tip end faces of the second arm parts 79. The frame part 77 is disposed in a ring-shaped recessed part which is provided between the cylindrical part 91 and the wall part 92 of the holder 9. As shown in FIG. 5, a pair of the first arm parts 78 is extended toward the first recessed parts 94 provided at diagonal positions in the first axis direction of the wall part 92. A pair of the second arm parts 79 is disposed in groove parts 95 provided at diagonal positions in the second axis direction of the wall part 92. Tip ends of a pair of the second arm parts 79 are protruded from the groove parts 95 to outer peripheral sides of the wall part 92 and are extended toward a pair of the second recessed parts 55 which are provided at diagonal positions in the second axis direction of the body part 51 of the case 5.

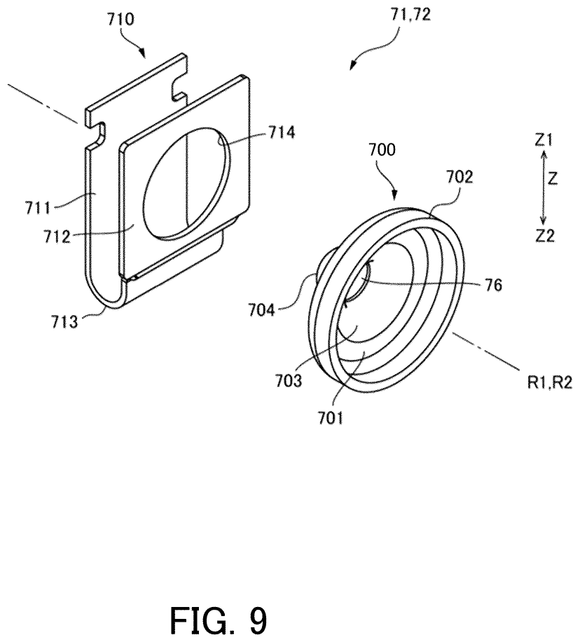

FIG. 9 is an exploded perspective view showing a contact member 700 and a spring member 710. A pair of the first swing support parts 71 and a pair of the second swing support parts 72 are respectively provided with the contact member 700 having the concave curved face 76 and the spring member 710 which energizes the contact member 700 toward the gimbal frame 70. The contact member 700 is manufactured by deep drawing processing of a metal plate. The spring member 710 is a plate spring which is structured by bending a metal plate in a U-shape. A plate thickness of the contact member 700 is larger than a plate thickness of the spring member 710. For example, in this embodiment, a plate thickness of the spring member 710 is 0.2 mm, and a plate thickness of the contact member 700 is 0.3 mm.

As shown in FIGS. 6, 7 and 9, the contact member 700 is provided with a circular bottom part 701 which faces a tip end of the shaft 74 of the gimbal frame 70, and a tube part 702 which is extended toward the gimbal frame 70 from an outer circumferential edge of the bottom part 701. A center of the bottom part 701 is provided with a recessed part 703 into which a tip end of the shaft 74 is inserted, and an inner face of the recessed part 703 is provided with the concave curved face 76. When a center part of the bottom part 701 in which the recessed part 703 is formed is viewed from a backside of the recessed part 703, a protruded part 704 is provided so as to protrude to an opposite side to the tube part 702.

The spring member 710 is provided with a plate part 711 which extends in the axial line direction, a receiving part 712 extending parallel to the plate part 711, and a bent part 713 connecting the plate part 711 with the receiving part 712. The receiving part 712 is provided with a hole 714 which is smaller than the bottom part 701 of the contact member 700 and is larger than the protruded part 704.

As shown in FIGS. 5 through 7, the first recessed part 94 of the holder 9 and the second recessed part 55 of the case 5 are disposed with the spring member 710 whose receiving part 712 faces an inner peripheral side, and the contact member 700 is disposed on an inner peripheral side with respect to the spring member 710. The spring member 710 is fixed to the first recessed part 94 or the second recessed part 55 by an adhesive not shown. The contact member 700 and the spring member 710 are assembled in a state that the bottom part 701 of the contact member 700 is in contact with the receiving part 712 of the spring member 710 from an inner peripheral side and the protruded part 704 of the contact member 700 is inserted into the hole 714 of the receiving part 712. An adhesive G is injected between the plate part 711 of the spring member 710 and the protruded part 704 of the contact member 700.

A tip end of the shaft 74 protruded from a tip end of the first arm part 78 of the gimbal frame 70 is inserted into the recessed part 703 of the contact member 700 which is disposed in the first recessed part 94. The contact member 700 is energized to an inner peripheral side through the receiving part 712. Therefore, a state is maintained that the concave curved face 76 of the contact member 700 is brought into point contact with the projecting curved face 75, which is provided at each end in the first axis direction of the gimbal frame 70, from an outer peripheral side by an energizing force of the spring member 710. As a result, the holder 9 is swingably supported by the gimbal frame 70 around the first axis R1.

Similarly, a tip end of the shaft 74 protruded from a tip end of the second arm part 79 of the gimbal frame 70 is inserted into the recessed part 703 of the contact member 700 which is disposed in the second recessed part 55. The contact member 700 is energized to an inner peripheral side through the receiving part 712. Therefore, a state is maintained that the concave curved face 76 of the contact member 700 is brought into point contact with the projecting curved face 75, which is provided at each end in the second axis direction of the gimbal frame 70, from an outer peripheral side by an energizing force of the spring member 710. As a result, the holder 9 is swingably supported around the second axis R2 by the case 5.

As shown in FIGS. 6 and 7, a tip end of the first arm part 78 and a tip end of the second arm part 79 of the gimbal frame 70 are inserted into an inner side of the tube part 702 of the contact member 700. Further, a depth of the recessed part 703 into which a tip end of the shaft 74 is inserted is deeper than a depth of the hemispheric concave curved face 76. Therefore, when a strong impact is applied by falling and the like, even if the receiving part 712 of the spring member 710 is resiliently bent toward the plate part 711, the tip end of the shaft 74 has little possibility of coming off from the recessed part 703. In addition, the tip end of the first arm part 78 and the tip end of the second arm part 79 have little possibility of coming off from an inner side of the tube part 702.

### First Stopper Member

As shown in FIG. 4, the first stopper member 11 is provided with a ring-shaped part 14 and a pair of protruding parts 15 which are protruded from the ring-shaped part 14 to both sides in the first axis direction. In this embodiment, the first stopper member 11 is formed in a plate shape. An inner circumferential edge of the ring-shaped part 14 is provided with a semicircular cut-out part 16 at a plurality of positions. In this embodiment, the cut-out part 16 is provided at four positions at an equal angular interval. As shown in FIGS. 3, 6 and 7, the first stopper member 11 is attached to an outer periphery of the cylindrical part 91 of the holder 9. The first stopper member 11 is located on an opposite side to the connection part 93 of the holder 9 with respect to the gimbal frame 70 in the axial line direction. Further, the first stopper member 11 is overlapped with the first swing support parts 71 from one side L1 in the axial line direction.

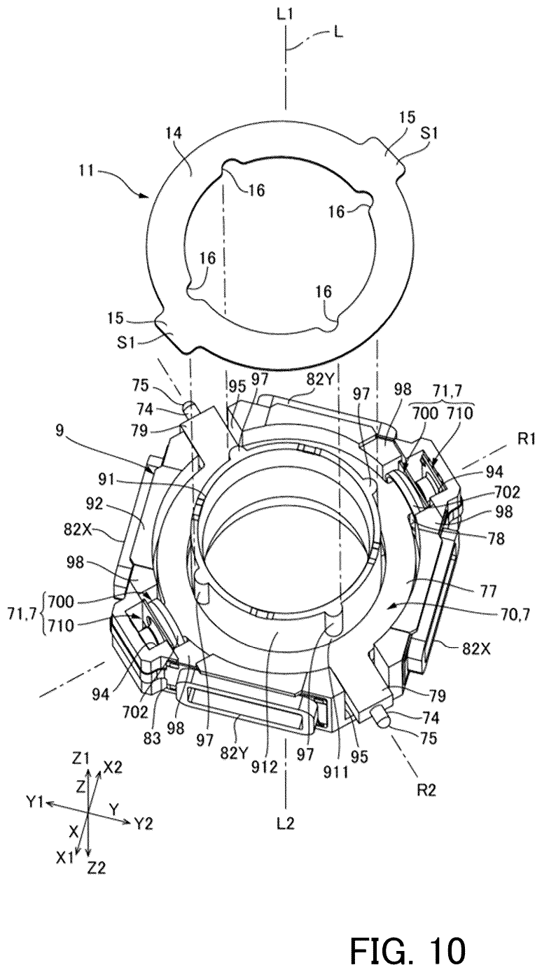

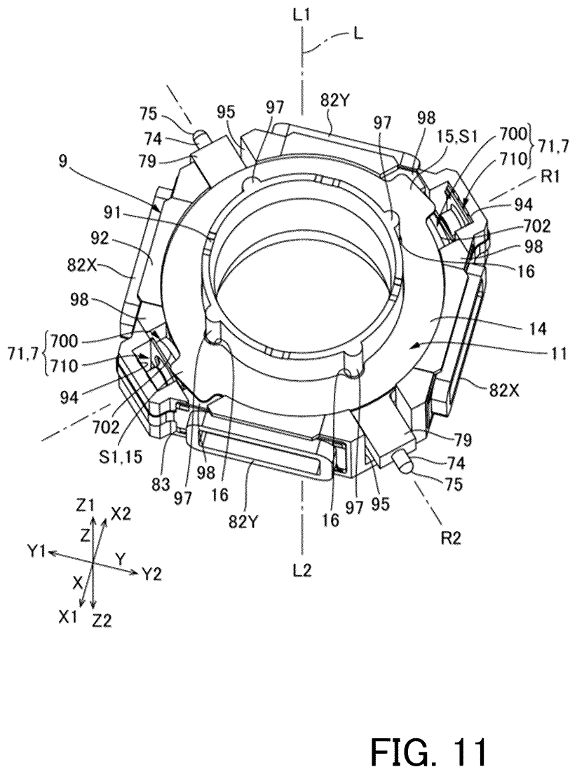

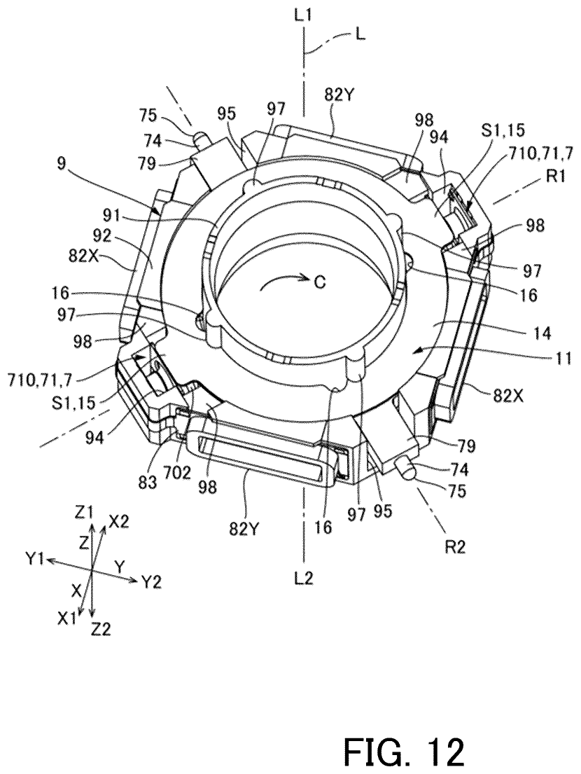

FIG. 10 is an exploded perspective view showing a state that angular positions of the cut-out parts 16 of the first stopper member 11 and the projections 97 provided on the tube part 91 of the holder 9 are aligned with each other. FIG. 11 is a perspective view showing a state that the first stopper member 11 is fitted to the holder 9 and is a perspective view showing a state before the first stopper member 11 is locked by the projections 97. FIG. 12 is a perspective view showing a state that the first stopper member 11 has been locked by the projections 97. Next, an assembling method of the first stopper member 11 will be described below with reference to FIGS. 10 through 12.

As shown in FIG. 10, the number and arrangement of the cut-out parts 16 provided at an inner circumferential edge of the first stopper member 11 are coincided with the number and arrangement of the projections 97 provided on an outer peripheral face of the cylindrical part 91. When the first stopper member 11 is to be fixed to the holder 9, first, as shown in FIG. 10, angular positions of the cut-out parts 16 and the projections 97 are matched and then, the cylindrical part 91 is passed through an inner side of the ring-shaped part 14. Then, as shown in FIG. 11, the protruding part 15 of the first stopper member 11 is brought into contact with a tip end face of the wall part 92.

As shown in FIG. 10, a tip end face of the wall part 92 is provided with stepped parts 98, which are recessed to the other side L2 in the axial line direction, at positions adjacent to the first recessed part 94 in a circumferential direction. As shown in FIG. 11, in a state that angular positions of the cut-out parts 16 and the projections 97 are matched, an angular position of the protruding part 15 of the first stopper member 11 is shifted from an angular position of the first recessed part 94, and the protruding part 15 is abutted with the stepped part 98 from one side L1 in the axial line direction.

As shown in FIGS. 10 and 11, the stepped part 98 is provided on both sides in a circumferential direction of the first recessed part 94. In FIGS. 10 and 11, the protruding part 15 is brought into contact with the stepped part 98 which is located on one side in the circumferential direction with respect to the first recessed part 94. In this embodiment, in a case that the first stopper member 11 is attached in a reversed manner with respect to a state shown in FIGS. 10 and 11, the protruding part 15 is brought into contact with the stepped part 98 which is located on the other side in the circumferential direction with respect to the first recessed part 94. Therefore, the first stopper member 11 can be attached to the holder 9 without discriminating its front side from its back side.

As shown in FIG. 11, in a state that the protruding part 15 is abutted with the stepped part 98, the projection 97 has passed the cut-out part 16. Therefore, the first stopper member 11 is turned to a direction shown by the arrow C in FIG. 12 in a circumferential direction and thereby, an angular position of the protruding part 15 is matched with an angular position of the first recessed part 94. As a result, the angular position of the cut-out part 16 is shifted from the angular position of the projection 97 and thus, the projection 97 is overlapped with an inner circumferential edge of the ring-shaped part 14 from one side L1 in the axial line direction. Therefore, the first stopper member 11 is locked by the projection 97 at the position shown in FIG. 12 and movement to the one side L1 in the axial line direction is restricted.

As shown in FIGS. 6 and 7, the ring-shaped part 14 of the first stopper member 11 is overlapped with the frame part 77 of the gimbal frame 70 from one side L1 in the axial line direction. Therefore, as shown in FIGS. 6, 7 and 12, when the first stopper member 11 is locked by the projection 97, the frame part 77 of the gimbal frame 70 is prevented from coming off from between the cylindrical part 91 and the wall part 92 to the one side L1 in the axial line direction.

The first stopper member 11 is provided with a first stopper part S1 which is overlapped with the first swing support part 71 disposed in the first recessed part 94 of the holder 9 from one side L1 in the axial line direction. In this embodiment, a tip end part of the protruding part 15 functions as the first stopper part S1. As shown in FIG. 6, the tip end part (first stopper part S1) of the protruding part 15 is extended to a position where the tip end part is overlapped with the first swing support part 71 disposed in the first recessed part 94 from one side L1 in the axial line direction. As described above, since the first stopper member 11 is locked by the projection 97, the first stopper part S1 restricts deformation of components structuring the first swing support part 71 and prevents falling-off of components structuring the first swing support part 71 from the first recessed part 94.

As shown in FIG. 6, the first recessed part 94 is provided with a first support part 99 which supports the first swing support part 71 from the other side L2 in the axial line direction. The first stopper part S1 faces the first support part 99 from one side L1 in the axial line direction. The first swing support part 71 is sandwiched and held by the first stopper part S1 and the first support part 99. In this embodiment, the first support part 99 is a bottom face of the first recessed part 94. The first support part 99 supports the tube part 702 of the contact member 700 of the first swing support part 71 from the other side L2 in the axial line direction. The tube part 702 is sandwiched and held by the first stopper part S1 and the first support part 99.

### Second Stopper Member

As shown in FIG. 3, the second stopper member 12 is provided with a pair of the magnet positioning parts 13X facing each other in the Y-direction, a pair of the magnet positioning parts 13Y facing each other in the X-direction, and four connecting parts 17 which connect the magnet positioning parts 13X and 13Y adjacent to each other in a circumferential direction. The connecting parts 17 are extended in directions inclined by 45 degrees with respect to the X-axis direction and the Y-axis direction. Upper frame parts 132 of the magnet positioning parts 13X and 13Y and the connecting parts 17 are connected with each other in an octagonal frame shape when viewed in the axial line direction.

As shown in FIG. 2, the connecting part 17 of the second stopper member 12 is contacted with a tip end face of the body tip end part 54 from one side in the axial line direction. As shown in FIG. 3, the tip end faces of the body tip end part 54 at diagonal positions in the first axis direction and at diagonal positions in the second axis direction are provided with stepped parts in a shape to which the connecting parts 17 are fitted. At diagonal positions in the second axis direction of the body tip end part 54, the stepped part to which the connecting part 17 extending in a direction intersecting the second axis direction is fitted is provided on both sides in a circumferential direction of the second recessed part 55. As described above, the second stopper member 12 is disposed on an inner face of the cover 3 and is sandwiched between a tip end face of the body tip end part 54 and the cover 3.

The second stopper member 12 is provided with a second stopper part S2 which is overlapped with the second swing support part 72 disposed in the second recessed part 55 of the case 5 from one side L1 in the axial line direction. In this embodiment, two connecting parts 17 disposed at diagonal positions in the second axis direction function as the second stopper part S2. As shown in FIG. 3, the connecting part 17 (second stopper part S2) located in the second axis direction is provided with a protruding part 18 protruding to the other side L2 in the axial line direction. As shown in FIG. 7, the second stopper part S2 is overlapped with the second swing support part 72 disposed in the second recessed part 55 from one side L1 in the axial line direction. The second stopper part S2 is prevented from disengaging from the case 5 by the cover 3. Therefore, deformation of components structuring the second stopper part S2 and the second swing support part 72 is restricted and falling-off of components structuring the second swing support part 72 from the second recessed part 55 is prevented.

As shown in FIG. 7, the second recessed part 55 is provided with a second support part 59 which supports the second swing support part 72 from the other side L2 in the axial line direction. The second stopper part S2 faces the second support part 59 from one side L1 in the axial line direction. The second swing support part 72 is sandwiched and held by the second stopper part S2 and the second support part 59. In this embodiment, the second support part 59 is a bottom face of the second recessed part 55. The second support part 59 supports the tube part 702 of the contact member 700 of the second swing support part 72 from the other side L2 in the axial line direction. The tube part 702 is sandwiched and held by the second stopper part S2 and the second support part 59.

### Operations and Effects

As described above, the unit 1 with a shake correction function in this embodiment includes the movable body 4, the support body 6, and the gimbal mechanism 7 which connects the movable body 4 with the support body 6 and swingably supports the movable body 4 with respect to the support body 6. The gimbal mechanism 7 includes the gimbal frame 70, a pair of the first swing support parts 71 which are brought into point contact with the gimbal frame 70 on the first axis R1, and a pair of the second swing support parts 72 which are brought into point contact with the gimbal frame 70 on the second axis R2. The movable body 4 includes a pair of the first support parts 99 which support a pair of the first swing support parts 71. The support body 6 includes a pair of the second support parts 59 which support a pair of the second swing support parts 72. In addition, the unit 1 in this embodiment includes a pair of the first stopper parts S1 which face a pair of the first support parts 99 in the axial line direction along the center axis line L, and a pair of the second stopper parts S2 which face a pair of the second support parts 59 in the axial line direction. The first stopper part S1 holds the first swing support part 71 between itself and the first support part 99, and the second stopper part S2 holds the second swing support part 72 between itself and the second support part 59.

In this embodiment, as described above, the first swing support part 71 and the second swing support part 72 of the gimbal mechanism are held between the stopper part and the support part facing each other in the axial line direction. Therefore, even when a strong impact is applied due to falling and the like, falling-off and deformation of components structuring the first swing support part 71 and the second swing support part 72 are restricted. As a result, the movable body 4 is prevented from coming off from the gimbal frame 70, and the gimbal frame 70 is prevented from coming off from the second swing support part 72. Accordingly, a risk of falling-off of the movable body 4 can be reduced.

In this embodiment, both of a pair of the first stopper parts S1 and a pair of the second stopper parts S2 are provided, but it may be structured that one of a pair of the first stopper parts S1 and a pair of the second stopper parts S2 is provided. When at least one of the first stopper parts S1 and the second stopper parts S2 is provided, the movable body 4 is prevented from coming off from the gimbal frame 70, or the gimbal frame 70 is prevented from coming off from the second swing support parts 72. Therefore, a risk of falling-off of the movable body 4 can be reduced.

The movable body 4 in this embodiment includes the holder 9 which holds the camera module 2 which is a swung object, and the first stopper member 11 which is separately provided from the holder 9. The holder 9 is provided with a pair of the first support parts 99, and the first stopper member 11 is provided with a pair of the first stopper parts S1. As described above, when the first stopper member 11 is separately provided from the holder 9, components structuring the first swing support part 71, and components structuring the first swing support part 71 which are attached to the holder 9 in the same direction as the first stopper member 11 can be sandwiched in the axial line direction. Therefore, assembling operations are easily performed in a state that falling-off and deformation of the first swing support part 71 are restricted.

The support body 6 in this embodiment includes the case 5 which surrounds the outer periphery of the movable body 4 and the second stopper member 12 which is separately provided from the case 5. The case 5 is provided with a pair of the second support parts 59, and the second stopper member 12 is provided with a pair of the second stopper parts S2. As described above, when the second stopper member 12 is separately provided from the case 5, components structuring the second swing support part 72, and components structuring the second swing support part 72 which are attached to the case 5 in the same direction as the second stopper member 12 can be sandwiched in the axial line direction. Therefore, assembling operations are easily performed in a state that falling-off and deformation of the second swing support part 72 are restricted.

In this embodiment, the first stopper part S1 may be provided in the holder 9. Even in a case that the first support part 99 and the first stopper part S1 are provided in the same member, a structure can be realized in which the first swing support part 71 is held between the first support part 99 and the first stopper part S1 facing each other in the axial line direction. Similarly, the second stopper part S2 may be provided in the case 5. Even in a case that the second support part 59 and the second stopper part S2 are provided in the same member, a structure can be realized in which the second swing support part 72 is held between the second support part 59 and the second stopper part S2 facing each other in the axial line direction.

In this embodiment, the support body 6 includes the cover 3 which is fixed to an end part in the axial line direction of the case 5, and the cover 3 positions the second stopper part S2 in the axial line direction. According to this structure, the second stopper member 12 can be prevented from coming off from the case 5 due to an impact.

The gimbal frame 70 in this embodiment is provided with four projecting curved faces 75 which are protruded to both sides in the first axis direction along the first axis R1 and to both sides in the second axis direction along the second axis R2. Each of a pair of the first swing support parts 71 and each of a pair of the second swing support parts 72 are respectively provided with the contact member 700 having the concave curved face 76 which is brought into point contact with the projecting curved face 75, and the spring member 710 which energizes the concave curved face 76 toward the projecting curved face 75. A plate thickness of the contact member 700 is larger than a plate thickness of the spring member 710. As described above, when the spring member 710 and the contact member 700 are separately structured from each other, a plate thickness of a portion which requires elasticity for applying a necessary energizing force can be made thinner, and a plate thickness of a portion which is desirable to prevent deformation is made larger to increase rigidity.

In this embodiment, the first stopper part S1 holds the contact member 700 between itself and the first support part 99, and the second stopper part S2 holds the contact member 700 between itself and the second support part 59. As described above, when the contact member 700 having the concave curved face 76 is sandwiched and held from both sides in the axial line direction, deformation and falling-off of the contact member 700 can be restricted. As a result, a state that the projecting curved face 75 is brought into point contact with the concave curved face 76 can be maintained.

The gimbal frame 70 in this embodiment includes the gimbal frame main body 73 and four shafts 74 which are protruded from both ends in the first axis direction of the gimbal frame main body 73 and protruded from both ends in the second axis direction of the gimbal frame main body 73. Each of the four shafts 74 is provided with the projecting curved face 75 at its tip end. The contact member 700 is provided with the bottom part 701 having the recessed part 703 into which a tip end of the shaft 74 is inserted, and the tube part 702 which is extended from an outer circumferential edge of the bottom part 701 toward the gimbal frame main body 73, and an inner face of the recessed part 703 is provided with the concave curved face 76. The first stopper part S1 holds the tube part 702 between itself and the first support part 99, and the second stopper part S2 holds the tube part 702 between itself and the second support part 59. As described above, since the tube part 702 is held in a sandwiched state in the axial line direction, deformation of the tube part 702 can be restricted. Further, even when a tip end of the shaft 74 is come off from the recessed part 703, coming-off of the shaft 74 from the contact member 700 can be prevented by the tube part 702. Therefore, a risk of coming-off of the gimbal frame 70 from the contact member 700 is reduced.

The contact member 700 in this embodiment is provided on a backside of the recessed part 703 with the protruded part 704 which is protruded toward the spring member 710. The spring member 710 is provided with the receiving part 712 having the hole 714 to which the protruded part 704 is fitted, and the concave curved face 76 is energized toward the projecting curved face 75 through the receiving part 712. According to this structure, in a state that the contact member 700 is held so as not to come off from the receiving part 712, the concave curved face 76 can be energized toward the projecting curved face 75 through the receiving part 712.

In this embodiment, the unit 1 with a shake correction function includes the swing magnetic drive mechanism 8 which has the first magnet 81X and the second magnet 81Y disposed on the support body 6 and the first coil 82X and the second coil 82Y which are disposed on the movable body 4 and face the first magnet 81X and the second magnet 81Y. The second stopper member 12 is provided with the magnet positioning part 13X which positions the first magnet 81X and the magnet positioning part 13Y which positions the second magnet 81Y. Therefore, the positional accuracy of the first magnet 81X and the second magnet 81Y is improved and assembling easiness can be enhanced.

The holder 9 in this embodiment is provided with the cylindrical part 91 which is extended in the axial line direction, the wall part 92 surrounding an outer periphery of the cylindrical part 91, and the connection part 93 which connects the cylindrical part 91 with the wall part 92, and the first swing support part 71 is disposed on the wall part 92. The gimbal frame 70 is provided with the frame part 77 accommodated between the cylindrical part 91 and the wall part 92, a pair of the first arm parts 78 protruding from the frame part 77 to both sides in the first axis direction, and a pair of the second arm parts 79 protruding from the frame part 77 to both sides in the second axis direction. A pair of the first arm parts 78 is extended to the first swing support parts 71, and a pair of the second arm parts 79 is extended to an outer side of the wall part 92. The first stopper member 11 is provided with the ring-shaped part 14, which is disposed on the opposite side to the connection part 93 in the axial line direction with respect to the frame part 77 and surrounds an outer periphery of the cylindrical part 91, and a pair of protruding parts 15 which are protruded from the ring-shaped part 14 to both sides in the first axis direction. The first stopper part S1 is provided at a tip end of the protruding part 15. As a result, the gimbal frame 70 can be prevented from falling off from the holder 9 by the first stopper member 11.

In this embodiment, the cylindrical part 91 of the holder 9 is provided with the base part 911 disposed on an inner side with respect to the wall part 92, and the tip end part 912 protruding from the inner side with respect to the wall part 92 in the axial line direction. The projection 97 is provided on an outer peripheral face of the tip end part 912, and the cut-out part 16 where the projection 97 is capable of passing is provided at an inner circumferential edge of the ring-shaped part 14. In a state that the angular positions of a pair of the protruding parts 15 and the angular positions of a pair of the first swing support parts 71 are matched with each other, the angular position of the cut-out part 16 and the angular position of the projection 97 are shifted and the inner circumferential edge of the ring-shaped part 14 and the projection 97 are overlapped with each other when viewed in the axial line direction. As described above, according to this embodiment, when the angular position of the first stopper member 11 is matched so that a tip end of the protruding part 15 functions as the first stopper part S1, the first stopper member 11 is locked by the projection 97. Therefore, a state that the first swing support part 71 is sandwiched and held in the axial line direction can be maintained.

### Technical Structure

Embodiments of the present invention may be structured as follows.
(1) A unit with a shake correction function including a movable body and a support body, and a gimbal mechanism which connects the movable body with the support body and swingably supports the movable body with respect to the support body. In a case that an axis intersecting a center axis line passing a swing center of the movable body at the swing center is defined as a first axis, and an axis intersecting the center axis line and the first axis at the swing center is defined as a second axis, the gimbal mechanism includes a gimbal frame, a pair of first swing support parts which are brought into point contact with the gimbal frame on the first axis, and a pair of second swing support parts which are brought into point contact with the gimbal frame on the second axis. The movable body includes a pair of first support parts which support a pair of the first swing support parts, and the support body includes a pair of second support parts which support a pair of the second swing support parts and, in addition, at least one of a pair of first stopper parts, which face a pair of the first support parts in an axial line direction along the center axis line, and a pair of second stopper parts facing a pair of the second support parts in the axial line direction is provided. The first stopper part holds the first swing support part between itself and the first support part, and the second stopper part holds the second swing support part between itself and the second support part.
(2) The unit with a shake correction function described in the above-mentioned structure (1), where the movable body includes a holder which holds a swung object and a first stopper member separately provided from the holder, the holder is provided with a pair of the first support parts, and the first stopper member is provided with a pair of the first stopper parts.
(3) The unit with a shake correction function described in the above-mentioned structure (1) or (2), where the support body includes a case surrounding an outer periphery of the movable body and a second stopper member separately provided from the case, the case is provided with a pair of the second support parts, and the second stopper member is provided with a pair of the second stopper parts.
(4) The unit with a shake correction function described in the above-mentioned structure (3), where the support body includes a cover which is fixed to an end part in the axial line direction of the case, and the cover positions the second stopper part in the axial line direction.
(5) The unit with a shake correction function described in one of the above-mentioned structures (1) through (4), where the gimbal frame is provided with four projecting curved faces which are protruded to both sides in a first axis direction along the first axis and to both sides in a second axis direction along the second axis, each of a pair of the first swing support parts and each of a pair of the second swing support parts respectively include a contact member provided with a concave curved face which is brought into point contact with the projecting curved face, and a spring member which energizes the concave curved face toward the projecting curved face, and a plate thickness of the contact member is larger than a plate thickness of the spring member.
(6) The unit with a shake correction function described in the above-mentioned structure (5), further including the first stopper part and the second stopper part, where the first stopper part holds the contact member between itself and the first support part, and the second stopper part holds the contact member between itself and the second support part.
(7) The unit with a shake correction function described in the above-mentioned structure (5) or (6), where the gimbal frame is provided with a gimbal frame main body and four shafts which are protruded from both ends in the first axis direction of the gimbal frame main body and from both ends in the second axis direction of the gimbal frame main body, a tip end of each of the four shafts is provided with the projecting curved face, the contact member is provided with a bottom part which has a recessed part into which a tip end of the shaft is inserted, and a tube part which is extended from an outer circumferential edge of the bottom part toward the gimbal frame main body, the projecting curved face is provided on an inner face of the recessed part, the first stopper part holds the tube part between itself and the first support part, and the second stopper part holds the tube part between itself and the second support part.
(8) The unit with a shake correction function described in the above-mentioned structure (7), where the contact member is provided with a protruded part protruding toward the spring member on a backside of the recessed part, the spring member is provided with a receiving part having a hole to which the protruded part is fitted, and the concave curved face is energized toward the projecting curved face through the receiving part.
(9) The unit with a shake correction function described in the above-mentioned structure (3) or (4), further including a swing magnetic drive mechanism having a magnet disposed on the support body and a coil which is disposed on the movable body and faces the magnet, where the second stopper member is provided with a magnet positioning part which positions the magnet.
(10) The unit with a shake correction function described in the above-mentioned structure (2), where the holder is provided with a cylindrical part which is extended in the axial line direction, a wall part which surrounds an outer periphery of the cylindrical part, and a connection part which connects the cylindrical part with the wall part, the first swing support part is disposed in the wall part, the gimbal frame is provided with a frame part which is accommodated between the cylindrical part and the wall part, a pair of first arm parts protruding to both sides in the first axis direction from the frame part, and a pair of second arm parts protruding to both sides in the second axis direction from the frame part, a pair of the first arm parts is extended to the first swing support parts, a pair of the second arm parts is extended to an outer side of the wall part, the first stopper member is provided with a ring-shaped part, which is disposed on an opposite side to the connection part in the axial line direction with respect to the frame part and surrounds an outer periphery of the cylindrical part, and a pair of protruding parts which are protruded from the ring-shaped part to both sides in the first axis direction, and a tip end of the protruding part is provided with the first stopper part.
(11) The unit with a shake correction function described in the above-mentioned structure (10), where the cylindrical part is provided with a base part which is disposed on an inner side of the wall part and a tip end part protruding in the axial line direction from the inner side of the wall part, an outer peripheral face of the tip end part is provided with a projection, an inner circumferential edge of the ring-shaped part is provided with a cut-out part through which the projection is capable of passing and, in a state that angular positions of a pair of the protruding parts and angular positions of a pair of the first swing support parts are matched, an angular position of the cut-out part and an angular position of the projection are shifted, and the inner circumferential edge of the ring-shaped part and the projection are overlapped with each other when viewed in the axial line direction.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A unit with a shake correction function comprising:
a movable body and a support body; and
a gimbal mechanism which connects the movable body with the support body and swingably supports the movable body with respect to the support body;
wherein in a case that an axis intersecting a center axis line passing a swing center of the movable body at the swing center is defined as a first axis, and an axis intersecting the center axis line and the first axis at the swing center is defined as a second axis,
the gimbal mechanism comprises a gimbal frame, a pair of first swing support parts which are brought into point contact with the gimbal frame on the first axis, and a pair of second swing support parts which are brought into point contact with the gimbal frame on the second axis;
the movable body comprises a pair of first support parts which support the pair of the first swing support parts;
the support body comprises a pair of second support parts which support the pair of the second swing support parts;
the unit further comprises at least one of a pair of first stopper parts, which face the pair of the first support parts in an axial line direction along the center axis line, and a pair of second stopper parts facing the pair of the second support parts in the axial line direction;
the first swing support part is held between the first stopper part and the first support part; and
the second swing support part is held between the second stopper part and the second support part.

2. The unit with a shake correction function according to claim 1, wherein
the movable body comprises a holder which holds a swung object and a first stopper member separately provided from the holder,
the holder comprises the pair of the first support parts, and
the first stopper member comprises the pair of the first stopper parts.

3. The unit with a shake correction function according to claim 1, wherein
the support body comprises a case surrounding an outer periphery of the movable body and a second stopper member separately provided from the case,
the case comprises the pair of the second support parts, and
the second stopper member comprises the pair of the second stopper parts.

4. The unit with a shake correction function according to claim 3, wherein
the support body comprises a cover which is fixed to an end part in the axial line direction of the case, and
the cover positions the second stopper part in the axial line direction.

5. The unit with a shake correction function according to claim 1, wherein
the gimbal frame comprises four projecting curved faces which are protruded to both sides in a first axis direction along the first axis and to both sides in a second axis direction along the second axis,
each of the pair of the first swing support parts and each of the pair of the second swing support parts respectively comprise a contact member provided with a concave curved face which is brought into point contact with the projecting curved face, and a spring member which energizes the concave curved face toward the projecting curved face, and
a plate thickness of the contact member is larger than a plate thickness of the spring member.

6. The unit with a shake correction function according to claim 5, further comprising the first stopper part and the second stopper part,
wherein the first stopper part holds the contact member between the first stopper part and the first support part, and
the second stopper part holds the contact member between the second stopper part and the second support part.

7. The unit with a shake correction function according to claim 6, wherein
the gimbal frame comprises a gimbal frame main body and four shafts which are protruded from both ends in the first axis direction of the gimbal frame main body and from both ends in the second axis direction of the gimbal frame main body,
a tip end of each of the four shafts comprises the projecting curved face,
the contact member comprises a bottom part which has a recessed part into which the tip end of the shaft is inserted, and a tube part which is extended from an outer circumferential edge of the bottom part toward the gimbal frame main body,
the projecting curved face is provided on an inner face of the recessed part,
the first stopper part holds the tube part between the first stopper part and the first support part, and
the second stopper part holds the tube part between the second stopper part and the second support part.

8. The unit with a shake correction function according to claim 7, wherein
the contact member comprises a protruded part protruding toward the spring member on a backside of the recessed part,
the spring member comprises a receiving part having a hole to which the protruded part is fitted, and
the concave curved face is energized toward the projecting curved face through the receiving part.

9. The unit with a shake correction function according to claim 3, further comprising a swing magnetic drive mechanism having a magnet disposed on the support body and a coil which is disposed on the movable body and faces the magnet,
wherein the second stopper member comprises a magnet positioning part which positions the magnet.

10. The unit with a shake correction function according to claim 2, wherein
the holder comprises a cylindrical part which is extended in the axial line direction, a wall part which surrounds an outer periphery of the cylindrical part, and a connection part which connects the cylindrical part with the wall part,
the first swing support part is disposed on the wall part,
the gimbal frame comprises a frame part which is accommodated between the cylindrical part and the wall part, a pair of first arm parts protruding to both sides in the first axis direction from the frame part, and a pair of second arm parts protruding to both sides in the second axis direction from the frame part,
the pair of the first arm parts is extended to the first swing support parts, and the pair of the second arm parts is extended to an outer side of the wall part,
the first stopper member comprises a ring-shaped part, which is disposed on an opposite side to the connection part in the axial line direction with respect to the frame part and surrounds an outer periphery of the cylindrical part, and a pair of protruding parts which are protruded from the ring-shaped part to both sides in the first axis direction, and
a tip end of the protruding part comprises the first stopper part.

11. The unit with a shake correction function according to claim 10, wherein
the cylindrical part comprises a base part which is disposed on an inner side of the wall part and a tip end part protruding in the axial line direction from the inner side of the wall part,
an outer peripheral face of the tip end part comprises a projection,
an inner circumferential edge of the ring-shaped part comprises a cut-out part through which the projection is capable of passing, and
in a state that angular positions of the pair of the protruding parts and angular positions of the pair of the first swing support parts are matched, an angular position of the cut-out part and an angular position of the projection are shifted, and
the inner circumferential edge of the ring-shaped part and the projection are overlapped with each other when viewed in the axial line direction.
